(19) United States
(12) Patent Application Publication
(10) Pub. No.: US 2019/0191763 A1
(43) Pub. Date: Jun. 27, 2019

(54) INFUSED TOOTHPICKS AND METHODS FOR PRODUCING THE SAME

(71) Applicant: Nicotine River, LLC, Simi Valley, CA (US)

(72) Inventor: Samuel S. Hong, Thousand Oaks, CA (US)

(21) Appl. No.: 16/232,940

(22) Filed: Dec. 26, 2018

Related U.S. Application Data
(60) Provisional application No. 62/610,474, filed on Dec. 26, 2017.

(51) Int. Cl. A24F 47/00; A61C 15/02; B27K 3/36

(52) U.S. Cl. CPC A24F 47/00; B27K 3/36; A61C 15/02

(57) ABSTRACT

Toothpicks infused with additives and methods for infusing those toothpicks are described.

This application claims the priority benefit of U.S. Provisional Patent Application No. 62/610,474 to Hong, filed on Dec. 26, 2017 and entitled “Infused Toothpicks and Methods for Producing the Same.” The priority provisional application is fully incorporated by reference herein in its entirety, including but not limited to the specification, claims, and figures thereof.

### BACKGROUND OF THE INVENTION

Toothpicks have been widely used for centuries to clean teeth. Toothpicks are advantageous for cleaning the mouth by removing food caught between teeth. However, toothpicks often do not have a pleasant taste and are not otherwise enjoyable. The common materials comprised in toothpicks, such as wood and plastic, have negligible taste and sometimes even an unpleasant bitter taste.

Smoking cigarettes is the most common method of consuming nicotine. However, many municipalities prohibit smoking in public and even private areas, making it difficult for smokers to satiate nicotine cravings. Other ways of consuming nicotine such as with dip or chew can be messy and are not always appropriate in specific social settings, and further, may be undesirable to certain users because of taste or other factors. Further, many of the common methods of consuming nicotine require bulky products to be carried on the consumer's person.

### FIELD OF THE INVENTION

Embodiments of the present invention relate to methods for producing infused toothpicks and, more specifically, flavoring- and/or nicotine-infused toothpicks comprised of porous material such as wood or a wood composite.

### BRIEF DESCRIPTION OF THE DRAWINGS

FIG. 1 shows a flow chart diagramming the method of creating infused toothpicks according to the disclosure.

### SUMMARY OF THE DISCLOSURE

Described herein are embodiments of a device and method for producing infused toothpicks, specifically infused toothpicks comprised of porous material including, but not limited to, wood or a wood composite.

In one embodiment of the disclosure, toothpicks are added to a basic water solution with a pH of about 8 or greater, such as for example water with sodium hydroxide. The solution is heated within a range of about 170° F. to about 185° F. and agitated as the toothpicks are completely submerged in the solution for about two to three hours, or at least two hours, or at least three hours. It should be understood that other time periods are possible and contemplated. The toothpicks are then dried and placed in an additive solution of flavoring, alcohol, and/or glycerin. In some embodiments, the additive solution also comprises nicotine, THC, and/or CBD, with one specific embodiment including nicotine. The toothpicks and additive solution can be placed in a vacuum with a pressure of about 0.80 bar to about 0.85 bar for a specified period of time. It should be understood that other pressure are possible. The toothpicks are then removed from the additive solution. A glycerin and alcohol mix can be added to the toothpicks, such as by submerging the toothpicks in the glycerin/alcohol mix and/or brushing the mix onto the toothpicks, and heated at a temperature, such as between about 140° F. and about 160° F., for approximately 15 minutes to 30 minutes. Finally, the toothpicks are cooled and stored.

These and other further features and advantages of the disclosure would be apparent to those skilled in the art from the following detailed description.

### DETAILED DESCRIPTION OF THE INVENTION

Embodiments of the present invention include a method for producing infused toothpicks, and/or the infused toothpicks themselves. Each process can produce a large quantity of the infused toothpicks at a time. In some embodiments, about 1,200 to about 2,000 infused toothpicks can be created at a time. In some embodiments, less than 1,200 infused toothpicks are created at a time. In other embodiments, more than 2,000 infused toothpicks are created at a time, such as about 2,000 to about 3,000, about 3,000 to about 5,000, or about 5,000 to about 10,000 or greater. The below process described creates about 1,200 to about 2,000 infused toothpicks at a time. For a higher or lower amount of infused toothpicks to be created in a single process, the size of containers and the amount of materials described below can be appropriately adjusted.

Toothpicks of various materials can be used for the present disclosure including, but not limited to, wood, wood composite, or any other porous material or composite known in the field that can safely be within a person's mouth.

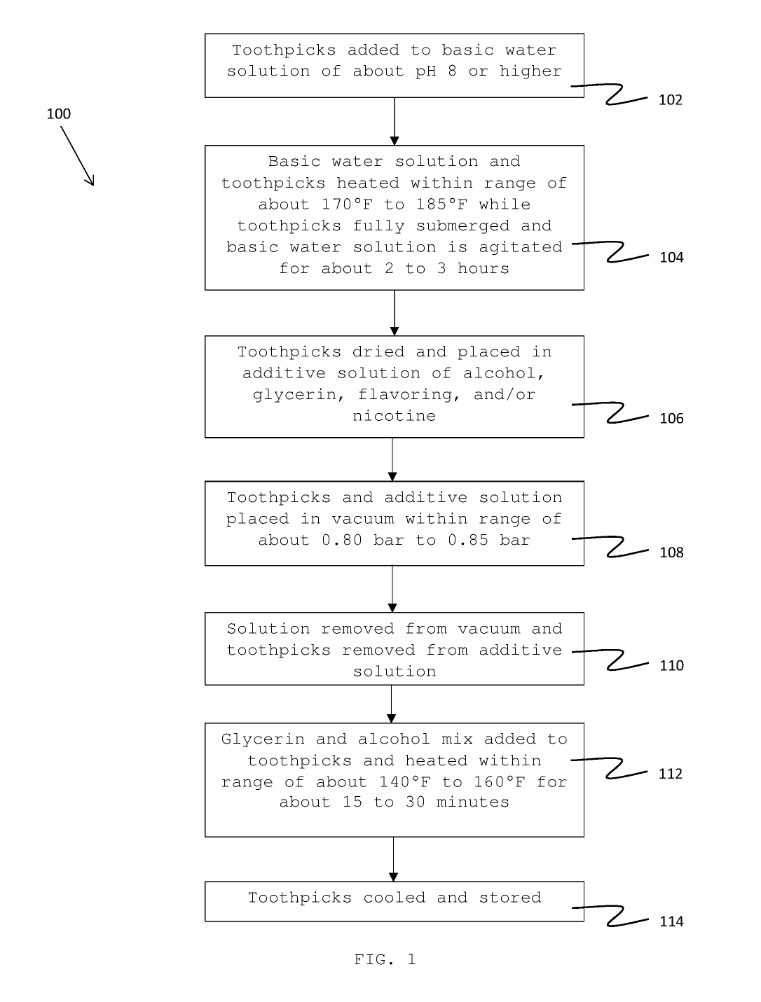

FIG. 1 shows a flow chart diagramming a method 100 of creating infused toothpicks according to the disclosure. In exemplary step 102, a basic water solution with a pH of about or higher is formed in a container using approximately 3500 mL of water, such as non-deionized water, and a sufficient amount of sodium hydroxide to result in a solution with a pH of about 8 or greater. The pH level of the basic water solution can be determined by a pH meter, a pH test strip, or any other measuring process known within the field. The container can be any container large enough to hold more than the basic water solution and made of a material that will not react to the basic water solution such as, for example, a 4 L glass beaker. Bases other than sodium hydroxide can also be used. In some embodiments, one or more bases can be used including, but not limited to, sodium hydroxide, magnesium hydroxide, and calcium hydroxide. It is understood that the volume measurements above can be adjusted as necessary by one of skill in the art.

Toothpicks are added to the basic water solution. In exemplary step 104, the basic water solution is heated to a temperature range between about 170° F. and about 185° F. and stirred as the toothpicks are completely submerged in the heated solution for about two to three hours. The heated basic water solution can be stirred manually or by a mixer such as a mixing bar that is agitated by a magnetic stirrer. In some embodiments, the basic water solution is heated to a temperature range of about 160° F. to about 190° F. In some embodiments, the basic water solution is heated to a temperature range of about 150° F. to about 200° F. Other temperatures are possible. The toothpicks can be submerged in the basic water solution by placing a weight or obstacle, such as a beaker (e.g., 500 mL or 1 L glass beaker), on or below the surface of the basic water solution. Other methods of submersion are possible.

In exemplary step 106, the toothpicks can then be removed from the basic water solution and dried. In some embodiments, the toothpicks are air dried and/or rotated to ensure each toothpick is dried and/or to speed up drying. In some embodiments, a heater is used to dry the toothpicks more quickly. The dry toothpicks can then be placed in an additive solution comprised of flavoring, alcohol, and/or glycerin, with one solution according to the present disclosure including all three of those ingredients. In some embodiments, the alcohol comprises ethanol. The glycerin can act as a masking agent and protective coating. The alcohol can act as a carrier. In some embodiments, the additive solution also comprises nicotine, as will be further discussed below.

In exemplary step 108, the toothpicks and additive solution can be placed in a vacuum with a pressure between about 0.80 bar and about 0.85 bar for a specified period of time, for example between approximately two to three hours. In some embodiments, the specified period of time can be approximately one to two hours. In some embodiments, the specified period of time can be approximately three or more hours. In some embodiments, the specified time can be approximately one or more hours. In some embodiments, the specified period of time can be two or more hours. In some embodiments, the specified period of time can be four hours or less. In some embodiments, the specified period of time can be three hours or less. In some embodiments, the vacuum is between about 0.70 bar and about 0.90 bar. In some embodiments, the vacuum is between about 0.60 bar and about 0.95 bar. In some embodiments, the vacuum is 0.85 bar or less. In some embodiments, the vacuum is 0.90 bar or less. Different pressures are possible.

The addition of nicotine in the additive solution results in infused toothpicks with nicotine and provides an easy and effective way for consumers who regularly smoke or otherwise consume nicotine to satisfy nicotine cravings. One benefit, for example, is that many public and private locations prohibit smoking, making it difficult for consumers to smoke cigarettes. The infused toothpicks with nicotine provide a convenient and enjoyable way to satiate nicotine cravings anywhere, while also preventing second hand smoke that can be irritating and harmful to non-smokers. Further, because the nicotine is carried in toothpicks, the nicotine can easily be carried while taking negligible space. Consumption of nicotine in this manner is also free of many of the detriments of smoking tobacco cigarettes, which often include harmful additives and produce cigarette tar.

In exemplary step 110, the toothpicks can then be removed from the additive solution. In exemplary step 112, a glycerin and alcohol mix can be added to the toothpicks, such as by submerging the toothpicks in the glycerin/alcohol mix, and the mix with the toothpicks therein can be heated to between about 140° F. and about 160° F. for approximately 15 minutes to 30 minutes. Other time periods, such as less than 15 minutes, 15 or more minutes, 30 or less minutes, or more than 30 minutes, are all possible. Alternatively the mix can be heated to this temperature prior to the toothpicks being placed in the mix, or the toothpicks can be covered in the mix (such as by brushing or another application method) and then heated. Combinations of these methods are possible. In some embodiments, the glycerin and alcohol mix is heated to between about 130° F. and about 170° F. In some embodiments, the glycerin and alcohol mix is heated to between about 120° F. and 180° F., or to between about 110° F. and about 190° F. In some embodiments, the mix is heated to a temperature between 130° F. and just below boiling, such as 205° F. In some embodiments, the approximate ratio of glycerin to alcohol is approximately 3:2. In some embodiments, the approximate ratio of glycerin to alcohol is between 1:1 and 5:2, inclusive or exclusive. In some embodiments, the alcohol can comprise ethanol. Finally, the toothpicks can be removed from the heat source, cooled, and stored.

The infused toothpicks can be stored in various ways. In some embodiments, multiple infused toothpicks are stored in a single container. In some embodiments, each flavored toothpick is individually wrapped for easy and sanitary transporting. Individually wrapped infused toothpicks can be placed in a pocket or purse while remaining in their individual wrappings.

Although the present invention has been described in detail with reference to certain preferred configurations thereof, other versions are possible. Embodiments of the present invention can comprise any combination of compatible steps described herein and/or shown in the FIGURE, and these embodiments should not be limited to those expressly illustrated and discussed. It is understood that embodiments of the present disclosure can include all of the method steps described herein with examples given as steps 102 through 114, or can include less than all of those steps, and/or can include additional steps. The steps according to embodiments of the present disclosure can be performed in different orders as would be understood by one of skill in the art. Therefore, the spirit and scope of the invention should not be limited to the versions described above.

We claim:

1. A method for creating an infused toothpick, comprising the steps of:
exposing a toothpick to a basic solution having a pH of 8 or greater;
removing said toothpick from said basic solution; and
adding an additive solution to said toothpick, said additive solution comprising flavoring and/or nicotine.

2. The method of claim 1, further comprising the step of heating said basic solution to approximately 160° F. or higher.

3. The method of claim 1, further comprising the step of drying said toothpick prior to adding said additive solution to said toothpick.

4. The method of claim 1, wherein said additive solution further comprises alcohol and glycerin.

5. The method of claim 4, wherein said additive solution further comprises nicotine.

6. The method of claim 1, wherein the adding additive solution step includes placing said additive solution and said toothpick in a vacuum of 0.85 bar or less.

7. The method of claim 1, further comprising adding a mix comprising glycerin and alcohol to said toothpick after the adding additive solution step.

8. The method of claim 7, further comprising the step of heating said mix to approximately 130° F. or higher.

9. The method of claim 1, wherein said basic solution comprises sodium hydroxide.

10. The method of claim 1, wherein said additive solution comprises nicotine.

11. A method for creating an infused toothpick, comprising the steps of:
exposing a toothpick to a basic solution;
removing said toothpick from said basic solution;
placing said toothpick in an additive solution, said additive solution comprising flavoring and/or nicotine;
removing said toothpick from said additive solution; and
adding a mix to said toothpick, said mix comprising glycerin and alcohol.

12. The method of claim 11, further comprising the step of heating said basic solution to approximately 160° F. or higher prior to and/or while said toothpick is exposed to said basic solution.

13. The method of claim 11, wherein said additive solution further comprises alcohol and glycerin.

14. The method of claim 13, wherein said additive solution comprises nicotine.

15. The method of claim 11, further comprising placing said additive solution with said toothpick therein under vacuum.

16. The method of claim 11, wherein said basic solution comprises sodium hydroxide.

17. A method for creating an infused toothpick, comprising:
placing one or more toothpicks in a basic water solution having a pH of 8 or greater;
heating said basic water solution to a temperature of about 170° F. to about 185° F.;
agitating said basic water solution for about 2 to 3 hours;
drying said toothpicks;
placing said toothpicks in an additive solution comprising alcohol and glycerin;
exposing said additive solution with said toothpicks therein to a vacuum;
removing said toothpicks from said additive solution;
adding a glycerin and alcohol mix to said toothpicks;
heating said toothpicks; and
allowing said toothpicks to cool.

18. The method of claim 17, wherein said additive solution comprises nicotine.

19. The method of claim 17, wherein said additive solution comprises flavoring.

20. The method of claim 17, wherein said additive solution comprises nicotine and flavoring.

21. The method of claim 17, wherein said vacuum is between about 0.80 bar and 0.85 bar.

22. The method of claim 17, wherein said heating comprises heating said toothpicks for about 15 to 30 minutes at a temperature of about 140° F. to about 160° F.
